(19) United States
(12) Patent Application Publication
(10) Pub. No.: US 2016/0008831 A1
(43) Pub. Date: Jan. 14, 2016

(54) SPRAY GUN ENHANCEMENT BACKPACK

(71) Applicant: Joseph Kumar, South Richmond, NY (US)

(72) Inventor: Joseph Kumar, South Richmond, NY (US)

(21) Appl. No.: 14/328,501

(22) Filed: Jul. 10, 2014

(51) Int. Cl. B05B 7/24; B05B 15/06

(52) U.S. Cl. CPC B05B 7/2475; B05B 7/2472; B05B 7/2416; B05B 15/061

(57) ABSTRACT

The spray gun enhancement backpack provides a lightweight and comfortable carrier which supports a spray gun conveniently at waist level, comprising an adjustable waist belt and harness configuration, further comprising a line for air and a line for paint originating from a pressure pot or optional backpack; further wherein the line for paint and line for air line are connected by connectors to flexible and retractable lines and extend down the user's back and to the user's waist then along the user's arm and attach to a spray gun.

### CLAIM OF PRIORITY

This patent application claims priority under 35 USC 119 (e) (1) from U.S. Provisional Patent Application Ser. No. 61/844,668 filed Jul. 10, 2013, of common inventorship herewith entitled, “Spray Gun Enhancement Back Pack.”

### FIELD OF THE INVENTION

The present invention pertains to the field of containers for storing and dispersing fluids, and more specifically to the field of portable containers with spraying devices.

### BACKGROUND OF THE INVENTION

The prior art has put forth several designs for portable containers with spraying devices. Among these are:

US Patent 2008/0172826 to Craig Rappin describes a backpack frame for a power blower and yard treatment sprayer system. The frame includes a first portion and a second portion extending outwardly from the first portion. The second portion is adapted for carrying the power blower thereon and has a hollowed out section. A cavity is further defined by the hollowed out section of the second portion and defined for holding a yard treatment mixture. A supply pipe is provided with a first end in communication with the cavity and a second inlet end positioned externally for filling the cavity with the yard treatment mixture. A tube is provided with a first end in communication with the cavity and a second exit end positioned externally from the frame and terminating into a flow of air defined by power blower. Lastly, the frame includes straps for attaching the frame on the back of an operator.

U.S. Pat. No. 7,886,571 to Matthias Muller and Thomas Stark describes a portable spraying device with an internal combustion engine and a blower driven by the internal combustion engine. A blower tube is connected to the blower and conveys a blowing air stream generated in the blower. A spraying agent reservoir is provided and a spraying agent line is connect to the reservoir and conveys a spraying agent stream from the reservoir into the blowing air stream. A control valve is arranged in the spraying agent line. A throttle control acts on the internal combustion engine for controlling an engine output. A stop switch acts on the internal combustion engine for interrupting ignition. An actuating element acts on the control valve for actuating the control valve to control the spraying agent stream. A handle with a handle head is provided and a throttle control, a stop switch and an actuating element are arranged in the handle head.

U.S. Pat. No. 3,199,785 to Heinz Schmierer describes a portable spraying device for dissemination of finely divided materials in a gas stream and, more particularly, to an apparatus adapted to be carried upon a user's back and provided with fluid displacing means together with a prime mover for spraying same.

None of these prior art references describe the present invention.

### SUMMARY OF THE INVENTION

It is an object of the present invention to provide a portable carrier that is worn on one's body for sprayable paint and related tools.

### BRIEF DESCRIPTION OF THE DRAWINGS

FIG. 1 is an illustrative prototypical view showing strap loops, connectors to a wearer's belt, a turbine motor, and receptacles for holding approximately three quarters to one gallon, one to one and one half quarts, and one gallon.

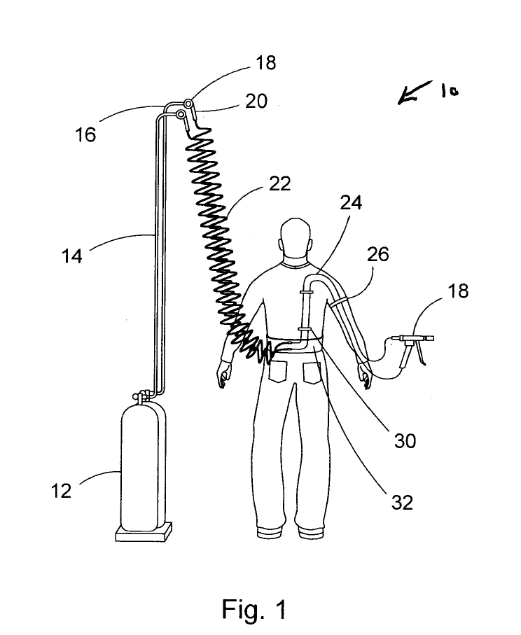

FIG. 2 is an illustrative prototypical view showing all related tools necessary for spraying paint including a pressure pot with a paint line and an air line attached to approximately one hundred eighty degree pivots, connectors, retractable lines, flexible lines, hook and loop fastener straps, a spray gun, a stabilizer clamp and a belt with a connector.

### DETAILED DESCRIPTION OF THE INVENTION

A fresh coat of paint vastly improves or completely alters the appearance of most homes. Whether using a neutral white or eggshell color to cover scuff marks, or a vibrant and bold color to change an entire scheme of a room, homeowners and designers use paint as a functional and a decorative medium. Consisting of pigments and emulsions suspended in a liquid base, paint also consists of countless compounds which are uniquely formulated to meet various requirements of hundreds of thousands of applications. Although the first paint was used in caves approximately thirty thousand years ago, ready mix paint became prominent during the middle eighteen hundreds when ready mix paint was patented. Within twenty years of this patent, factories which specialized in paint production sprang up across the nation. Today, the paint industry is booming as never before.

Rolling paint on a bedroom wall or touching up trim are relatively easy jobs that are completed in a short amount of time. Larger surface areas, such as the exteriors of homes, boats and cars, are too daunting to attempt with only a brush and paint can. A spray gun that utilizes compressed air is employed to expediently and evenly coat paint over such large areas. A spray gun system helps to save time and much physical labor, but also presents challenges. Consisting of a nozzle, paint basin and air compressor, spray gun systems are heavy and are difficult to manage during the spraying process. In addition to strained muscles, spray gun systems sometimes result in a time consuming paint task with the user constantly setting it down and repositioning the burden to achieve a comfortable yet accurate aim.

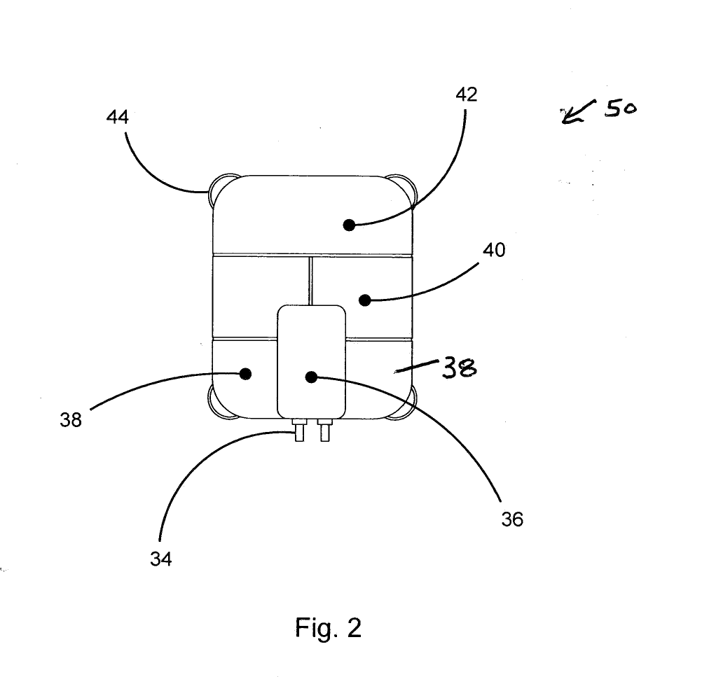

The present invention, hereinafter referred to as the Spray Gun Enhancement Back Pack, is a portable carrier that is worn on one's body and configured to store paint and related tools for applying the paint to a surface. The present invention provides a more user friendly means of transporting and accessing paint when completing various large painting projects that typically require spraying. The Spray Gun Enhancement Back Pack 10 is a wearable support system for use in storing, transporting and accessing sprayable paint. This system is comprised of a belt and harness configuration manufactured of lightweight yet durable leather, nylon or similar material. The adjustable waist belt 32 comprises a snap fit clip or click closure for securing the belt 32 behind one's back or in front around one's waist. Extending from the belt 32 are two flexible and retractable lines 22, one for air 16 and one for paint 14, that originate from a pressure pot 12 or optional backpack (FIG. 2).

The paint line 14 and air line 16 are connected by connectors 20 from pressure pot 12 to a stopper at a point just after a set of 180 degree pivotal pulleys 18. Paint line 14 and air line 16 exit pressure pot 12 to pivots 18 and connect to retractable lines 22.

Retractable lines 22 extend from pivots 18 to the belt 32 and move upwards along the user's back from the user's waist by flexible lines 24 to secure around a user's arm by a hook and loop strap 26 and then attach to a spray gun 28. Stabilizer clamps 30 secure the lines 24 to the user's back.

The Spray Gun Enhancement Back Pack is available with an optional back pack 50, shown in FIG. 2. Loops 44 are capable of receiving straps for wearing as a backpack. Connectors 34 provide means for attaching the backpack device to a the user's belt 32. Fabricated of durable materials and resembling a standard backpack, this backpack component is integrally connected to the belt system. One embodiment of the backpack is comprised of a hard case which is divided into sections providing a capability to store two selections of paint in two separate reservoirs 38 capable of holding up to approximately one quart. A third reservoir 40 accommodates storing paint thinner utilized for clearing and cleaning the paint line and holds up to about one and one half quarts. A second embodiment of the backpack is comprised of a hard case which is divided into sections providing a capability to store four selections of paint in four separate reservoirs with two lower reservoirs 38 each capable of holding approximately one quart of paint, one middle reservoir 40 capable of holding approximately one and one half quarts of paint, and one top reservoir 42 capable of holding approximately one gallon of paint. A fifth reservoir accommodates storing paint thinner utilized for clearing and cleaning the paint line. Both backpack embodiments are produced with a functionality to house different paint colors and spray simultaneously to create a technique for a unique color effect and distribution. A battery operated turbine motor 36 actuates a compressor which replaces a standard pressure pot when utilizing the backpack. The backpack 50 integrally connects and operates with a belt system that is worn around a user's waist. The backpack frees a user from manually managing a weighty and cumbersome compressor. When filled with paint and paint thinner to full capacity, the present invention weighs approximately thirty five pounds. The Spray Gun Enhancement Back Pack is produced in an array of attractive colors as well as neutral black, navy and white.

The Spray Gun Enhancement Back Pack provides a more simple and efficient means of carrying, accessing and using sprayable paint when completing large painting tasks. Eliminating the need to handle the spray gun in one hand and the hoses in the other hand while attempting to neatly paint, the Spray Gun Enhancement Back Pack frees one hand to allow a user to hold a shield to allow painting the ceiling and wall in one day with precision. The present invention also prevents hoses from being on the ground which presents a safety hazard.

A lightweight and comfortable carrier which supports a spray gun conveniently at waist level, the Spray Gun Enhancement Back Pack eliminates having to place the tool on the ground and pick it back up between uses. This advantage saves much time and labor costs in a painting project. Fully adjustable, the present invention is comfortable to wear, distributes an air compressor's weight evenly across a painter's back and shoulders, and eliminates muscle tension and strain associated with trying to manage these implements by hand. Durably and ergonomically constructed of high quality materials and components, the Spray Gun Enhancement Back Pack will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable carrier system worn on a human body for sprayable paint and related tools, comprising: an adjustable waist belt and harness configuration, wherein the adjustable waist belt comprises a snap fit clip or click closure for securing the belt behind a user's back or in front around a user's waist, further comprising a line for air and a line for paint originating from a pressure pot or optional backpack; further wherein the line for paint and line for air line are connected by connectors from the pressure pot to a stopper at a point after a set of 180 degree pivotal pulleys, wherein paint line and air line connect to one flexible and retractable line for air after the pulley and one flexible and retractable line for paint after the pulley and extend down the user's back and to the user's waist then along the users arm and attach to a spray gun.

2. The portable carrier system of claim 1, wherein the flexible and retractable lines are secured to a user's arm by hook and loop fasteners.

3. The portable carrier system of claim 1, further comprising stabilizer clamps to secure the lines to the user's back.

4. The portable carrier system of claim 1, wherein the optional backpack is comprised of a hard case which is divided into sections providing a capability to store two selections of paint in two separate reservoirs wherein each reservoir is capable of holding up to approximately one quart, further comprising a third reservoir accommodates storing paint thinner utilized for clearing and cleaning the paint line and wherein the third reservoir holds up to about one and one half quarts, further wherein the backpack integrally connects to and operates with a belt system that is worn around a user's waist.

5. The portable carrier system of claim 4, wherein connectors provide means for attaching the backpack device to a the user's belt.

6. The portable carrier system of claim 4, further comprising loops capable of receiving straps attached to the backpack.

7. The portable carrier system of claim 1, wherein the optional backpack is comprised of a hard case which is divided into sections providing a capability to store four selections of paint in four separate reservoirs comprising two lower reservoirs, wherein each lower reservoir is capable of holding approximately one quart of paint, one middle reservoir capable of holding approximately one and one half quarts of paint, and one top reservoir capable of holding approximately one gallon of paint, further comprising a fifth reservoir for storing paint thinner utilized for clearing and cleaning the paint line, further wherein the backpack integrally connects to and operates with a belt system that is worn around a user's waist.

8. The portable carrier system of claim 4, further comprising a battery operated turbine motor capable of actuating a compressor which replaces a standard pressure pot when utilizing the backpack.

9. The portable carrier system of claim 7, further comprising a battery operated turbine motor capable of actuating a compressor which replaces a standard pressure pot when utilizing the backpack.

10. The portable carrier system of claim 4, wherein the backpack is produced in an array of attractive colors as well as neutral black, navy and white.

11. The portable carrier system of claim 7, wherein the backpack is produced in an array of attractive colors as well as neutral black, navy and white.

12. The portable carrier system of claim 1, wherein the adjustable waist belt and harness configuration are manufactured of lightweight yet durable leather, nylon or similar material.
